(19) United States
(12) Patent Application Publication
(10) Pub. No.: US 2012/0152670 A1
(43) Pub. Date: Jun. 21, 2012

(54) Damping Device

(75) Inventors: Ludovic Chauvet, Mauves/Loire (FR); Arnaud Gattepaille, Clisson (FR)

(73) Assignee: TRELLEBORG AUTOMOTIVE GERMANY GMBH, Breuberg (DE)

(21) Appl. No.: 13/386,821

(22) PCT Filed: Jul. 12, 2010
(86) PCT No.: PCT/EP2010/060000

§ 371 Date: Mar. 12, 2012

(30) Foreign Application Priority Data
Jul. 24, 2009 (DE) 10 2009 034 677.5

(51) Int. Cl. F16F 9/19; F16F 9/50; F16F 9/34

(52) U.S. Cl. 188/266.2

(57) ABSTRACT

A damping device for a motor vehicle is particularly suited for damping starting and stopping impacts of a motor vehicle engine. The device has first and second chambers filled with a damping medium and separated by an intermediate plate. The chambers are each bounded by a bellows and by a face plate. A damping channel connecting the chambers is formed in the intermediate plate. In order to achieve a damping effect depending on the operating mode of the motor vehicle engine, the two chambers are connected by at least one bypass channel, which can be selectively opened or closed by way of a switchable valve. The switched state of the valve depends on the operating mode of the motor vehicle. There is also described a damping system for damping the starting and stopping impacts of a motor vehicle engine.

The present invention relates to a damping device for a motor vehicle, in particular for damping starting and stopping impacts of a motor vehicle engine, having a first and a second chamber which are filled with a damping medium and are separated by an intermediate plate, wherein the chambers are each bounded by a folding bellows and by a face plate, wherein a damping duct connecting the chambers is formed in the intermediate plate. Furthermore, the invention relates to a damping system having such a damping device.

In order to reduce the consumption of fuel, modern motor vehicles frequently have what is referred to as a start and stop system which switches off the motor vehicle engine when it is not required, such as for example when it is stopped at a traffic light. The method of functioning of this system can be described as follows with reference to a stop at a traffic light. If the driver stops at a traffic light and switches into the idling mode, the motor vehicle engine switches off when the clutch is released. In order to drive off, the driver activates the clutch and the engine is started again. In the starting and stopping processes mentioned above, severe impacts of the engine occur, and these can be felt in the passenger cell and consequently limit the driving comfort.

U.S. Pat. No. 6,082,508 discloses a damping device of the type mentioned at the beginning which is provided for use in a satellite. The damping device has an intermediate plate and two folding bellows which each extend away from the intermediate plate in opposing longitudinal directions. At their front sides, the folding bellows are closed off by means of a plate in such a way that two working chambers are formed. The two chambers are connected to one another via a duct in the intermediate plate. A compressible fluid, in particular air, is used as the working medium. For the purpose of damping, the compressible fluid flows from one chamber to the other chamber via the damping duct, wherein the damping effect is generated as a result of the friction occurring in the duct.

The invention is based on the object of providing a damping device which damps the starting and stopping impacts of a motor vehicle engine and is free of a damping effect in the travel mode.

In order to achieve this object, it is proposed in a damping device of the type mentioned at the beginning that the two chambers are connected to at least one bypass duct, wherein the bypass duct can be opened and closed by means of a switchable valve, and wherein the switched state of the valve depends on the operating state of the motor vehicle.

Advantageous refinements are the subject matter of the dependent claims.

In the damping device according to the invention, the damping can be changed as a function of the operating state of the engine by means of the switchable valve. In a first switched position, the bypass duct is closed, and the expelled air therefore flows via the damping duct which is arranged between the chambers. As a result, in particular the impacts which occur during starting and stopping are damped. In a second switched position, the bypass duct is opened, and the expelled air therefore flows via the bypass duct and not via the damping duct. As a result, in this switched position no damping occurs. Owing to the low degree of rigidity of the folding bellows, humming does not occur even at high frequencies. The damping device according to the invention therefore improves the driving comfort.

The bypass duct advantageously has a larger cross section than the damping duct. This directs the air via the bypass duct when said duct is opened, with the result that no damping occurs in the driving mode.

The bypass duct is advantageously formed in the intermediate plate.

In a further advantageous refinement, the bypass duct connects the two chambers to the surroundings. The bypass duct therefore permits the damping medium to flow out of the two chambers and into the surroundings, as a result of which the damping duct is bypassed.

In a further refinement, the bypass duct connects the two chambers to one another.

In a further refinement, a first bypass duct is formed in the first face plate in order to connect the first chamber to the surroundings, and a second bypass duct is formed in the second face plate in order to connect the second chamber to the surroundings.

The valve is advantageously embodied as a valve which can be adjusted incrementally or in an infinitely variable fashion. The cross section of the bypass duct can thus be advantageously adapted to the respective pitching frequency of the motor vehicle engine.

The valve can advantageously be switched by means of a vacuum or electromagnetically. Such valves are, on the one hand, cost-effective and, on the other hand, have a high degree of reliability.

In a further advantageous refinement, air is used as the damping medium. Air bearings are more cost-effective than hydraulic bearings since there is no need for filling with damping fluid.

The folding bellows are advantageously arranged coaxially with respect to the damping duct.

The first face plate is advantageously attached to the front side of the first folding bellows, and the second face plate is attached to the front side of the second folding bellows.

The folding bellows advantageously have a length of 5 mm to 20 mm, preferably of 5 mm to 10 mm. Furthermore, the folding bellows advantageously have an outer diameter of 70 mm to 100 mm, preferably of 80 mm to 90 mm. Owing to the dimensions of the folding bellows, an advantageous small chamber volume and a large pumping area are made available, with the result that a satisfactory damping effect can be achieved.

The folding bellows are advantageously manufactured from a thermoplastic elastomer (TPE) or a thermoplast (TP). The folding bellows therefore have a long service life accompanied by constant material properties.

The present invention also relates to a damping system for damping starting and stopping impacts of a motor vehicle engine, which system has a damping device according to the invention and a control device for controlling the switchable valve of the damping device as a function of the operating state of the motor vehicle engine. The switchable valve of the damping device is actuated by means of the control device as a function of the operating state of the motor vehicle engine.

The switchable valve is advantageously closed during the starting and stopping process of the motor vehicle engine and opened in the driving mode. Damping therefore advantageously occurs during the starting and stopping of the motor vehicle engine and no damping occurs in the driving mode.

The invention will be explained in more detail below with reference to exemplary embodiments which are illustrated schematically in the drawings, in which:

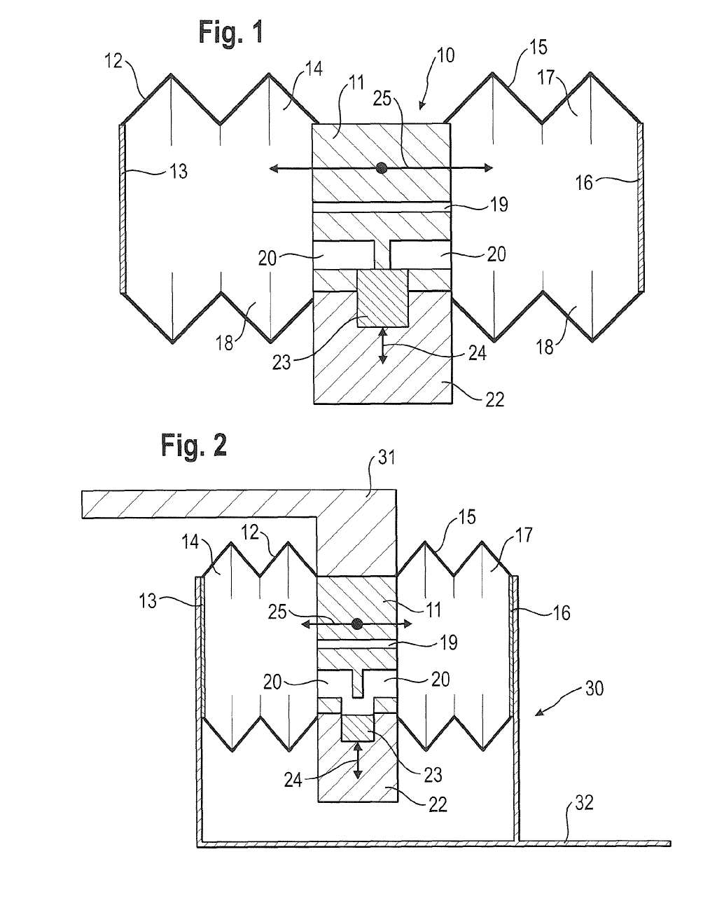

FIG. 1 shows a horizontal section through a first embodiment of the damping device according to the invention;

FIG. 2 shows a horizontal section through the damping device according to the invention with connecting elements attached thereto;

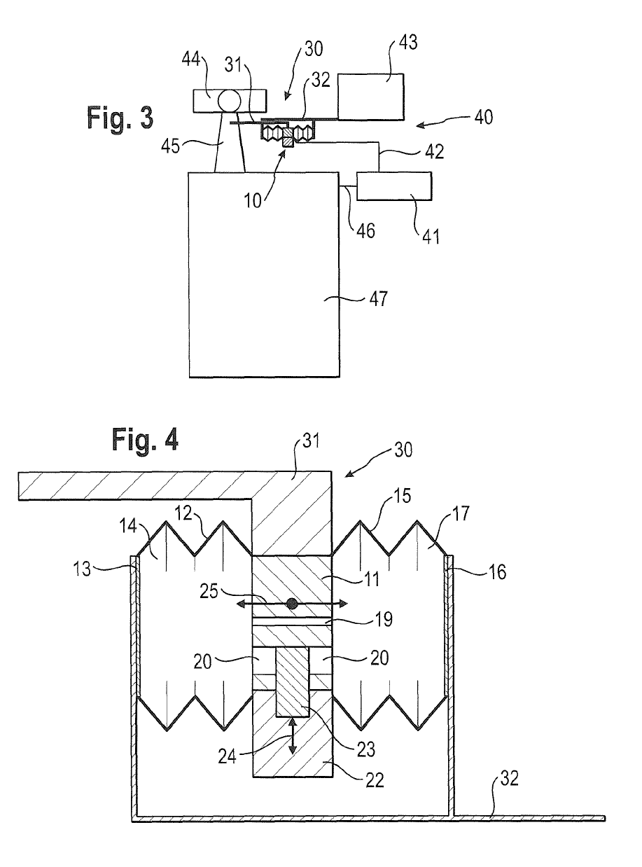

FIG. 3 shows a schematic illustration of the damping system according to the invention;

FIG. 4 shows a horizontal section through a second embodiment of the damping device according to the invention;

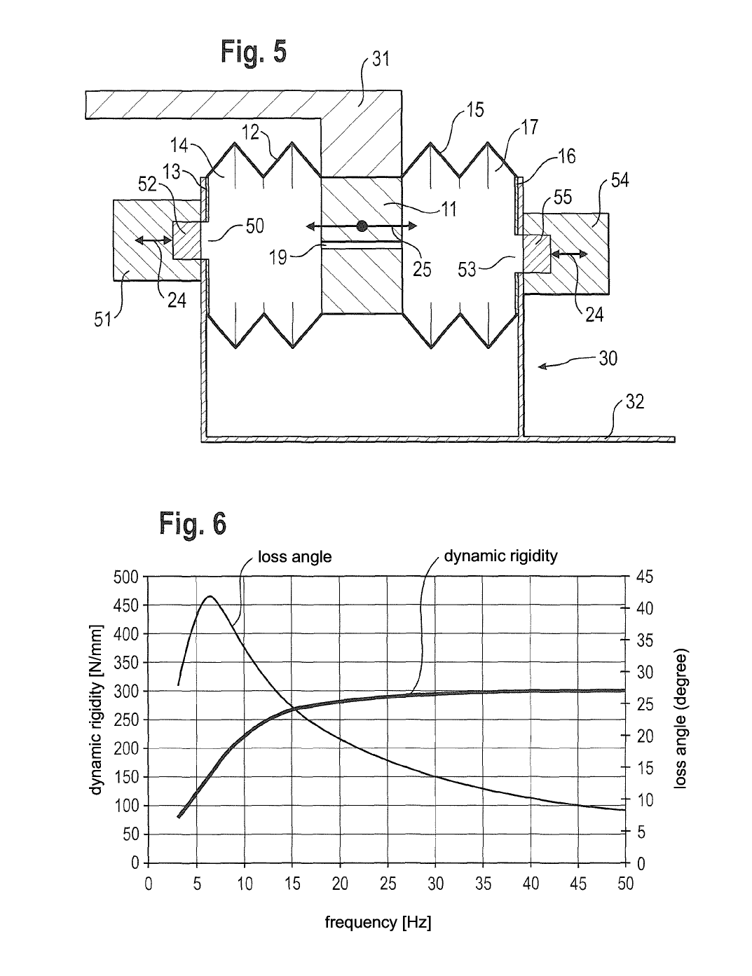

FIG. 5 shows a horizontal section through a third embodiment of the damping device according to the invention;

FIG. 6 shows a graphic illustration of the damping and rigidity characteristics of the damping device according to the invention during the starting and stopping process, and

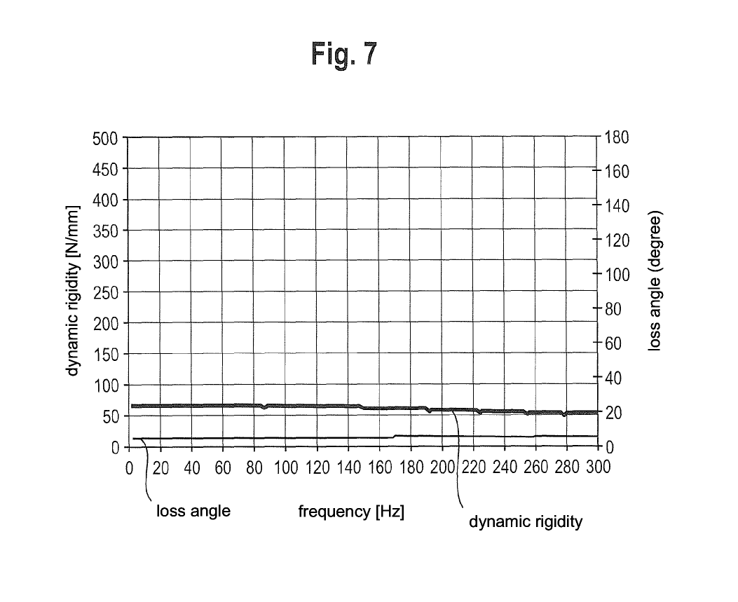

FIG. 7 shows a graphic illustration of the damping and rigidity characteristics of the damping device according to the invention during the driving mode.

FIG. 1 shows a damping device 10 which is provided for damping starting and stopping impacts of a motor vehicle engine 47 which is installed transversely and which has a start/stop system. The damping device 10 has an intermediate plate 11, a first folding bellows 12, a first face plate 13, a second folding bellows 15 and a second face plate 16. The folding bellows 12, 15 are connected at a first end region to the intermediate plate 11. At a second end region, the face plate 13, 16 is provided.

The intermediate plate 11, the first folding bellows 12 and the first face plate 13 form a first working chamber 14. The intermediate plate 11, the second folding bellows 15 and the second face plate 16 form a second working chamber 17. The two working chambers 14, 17 are connected to one another via a damping duct 19 which is formed in the intermediate plate 11. A damping medium 18, in particular air, is located within the working chambers 14, 17. Furthermore, a bypass duct 20, which connects the first chamber 14 and the second chamber 17 to the surroundings, is formed in the intermediate plate 11. The bypass duct 20 has a larger diameter than the damping duct 19.

The intermediate plate 11 is composed of a metallic material, but it can also be manufactured from a plastic. The folding bellows 12, 15 are composed of a thermoplastic elastomer (TPE) or a thermoplast (TP) and have a length of 5 mm to 20 mm and an outer diameter of 70 mm to 100 mm. The face plates 13, 16 are also composed of a metallic material, but they can also be composed of a plastic.

In order to form the chambers 14, 17, the folding bellows 12, 15 extend away from the intermediate plate, coaxially with respect to the damping duct 19, wherein the folding bellows 12, 15 extend in opposing directions. The open front sides of the folding bellows 12, 15 are each closed off with a face plate 13, 16. Generally known connecting methods such as, for example, bonding are used to connect the folding bellows 12, 15 to the intermediate plate 11 and to the respective face plates 13, 16.

According to FIG. 1, a switchable valve 22 is attached to the intermediate plate 11 of the damping device 10. The switchable valve 22 has an actuating element 23 which can be switched in a known fashion by means of a vacuum or electromagnetically. The actuating element 23 opens or closes the bypass duct 20, as is illustrated with the aid of the double arrow 24 shown in FIG. 1. The valve can also be embodied in an incremental or infinitely variable fashion. This makes it possible to adjust the duct cross section of the bypass duct 20 in an incremental or infinitely variable fashion between zero and the maximum cross section. The damping device 10 can therefore be adapted in an optimum way to the pitching frequency of the motor vehicle engine 47.

FIG. 1 shows the damping device in a first switched position in which the bypass duct 20 is closed by the actuating element 23. This corresponds to the switched state during the starting and stopping of the motor vehicle engine 47.

FIG. 2 shows the damping device 10 in a second switched position in which the bypass duct 20 is opened. In this switched position, the expelled air flows into the surroundings via the bypass duct 20, so that no damping occurs.

Furthermore, FIG. 2 illustrates an attachment device 30 for attaching the damping device 10 to the motor vehicle engine 47 and the bodywork of the vehicle. The attachment device 30 has an engine-side connecting element 31 which connects the intermediate plate 11 of the damping device 10 to the motor vehicle engine 47, and a wheel-house-side connecting element 31 for connecting the damping device 10 to the bodywork of the vehicle. The wheel-house-side connecting element 32 is respectively connected to one of the face plates 13, 16, so that it engages around the damping device 10.

FIG. 3 is a schematic illustration of the damping system 40. The damping system 40 has the damping device 10, a control device 41, a first transmission device 42 for connecting the control device 41 to the switchable valve 22, and a second transmission device 46 for connecting the motor vehicle engine 47 to the control device 41. In order to integrate the damping device 10 into the damping system 40, the damping device 10 is connected via the engine-side connecting element 31 to an engine holder 45, which is connected to an engine bearing 44 (not defined in more detail), and to a wheel house 43 via the wheel-house-side connecting element 32.

The method of functioning of the damping system 40 will be described below. During a starting and stopping process of the motor vehicle engine 47 which is installed transversely, the latter carries out pitching movements about the transverse axis of the vehicle. By means of the second transmission device 46, the information that this is a starting and stopping process is passed on to the control device 41. The information is processed in the control device 41 in such a way that the switchable valve 22 is actuated via the first transmission device 42 in such a way that the actuating element 23 closes off the bypass duct 20. Consequently, the damping device 10 is in the state illustrated in FIG. 1. The pitching movements of the motor vehicle engine 40 are therefore transmitted to the holder 45, and said pitching movements are in turn transmitted to the engine-side connecting element 31, with the result that the intermediate plate 11 moves in the longitudinal direction of the vehicle, as is illustrated by the double arrow 25 in FIG. 2. As a result of the movement of the intermediate plate 11, the damping fluid 18 flows alternately from one chamber 14 into the other chamber 17 via the damping duct 19. Owing to the small cross section of the damping duct 19, a friction effect is generated which brings about a damping effect.

In the driving mode, the switchable valve 22 is actuated with the aid of the first transmission device 42 in such a way that the actuating element 23 opens the bypass duct 20, as is illustrated in FIG. 2. The pitching movements of the motor vehicle engine 47 which occur during the driving mode are therefore not damped. The reason for this is, on the one hand, that the damping medium 18 which is present in the two working chambers 14, 17 is discharged into the surroundings via the bypass duct 20 and, on the other hand, that the folding bellows 12, 15 have a low static basic rigidity. This counteracts humming in the driving mode and at the same time improves the driving comfort.

FIG. 4 shows a second embodiment of the damping device 10 which differs from the damping device 10 according to FIGS. 1 and 2 in that the bypass duct 20 connects the chambers 14, 17 to one another, wherein the bypass duct 20 can be opened or closed by means of the actuating element 23. In order to achieve a damping effect, the bypass duct 20 is closed off with the aid of the actuating element 23. In order to produce no damping effect in the driving mode, the actuating element 23 is moved into a position which opens the bypass duct 20.

FIG. 5 shows a third embodiment of the damping device 10 according to the invention. The damping device 10 according to the third embodiment differs from the two other embodiments in that in each case a bypass duct 50, 53 is formed in the face plate 13, 16, wherein each bypass duct 50, 53 can be respectively opened and closed by means of a switchable valve 51, 54. A first bypass duct 50 is formed in the first face plate 13, wherein the first switchable valve 51 is formed on the first face plate 13, the first actuating element 52 of which valve 51 closes or opens the first bypass duct 50. A second bypass duct 53, which can be opened or closed by means of a second actuating element 55 of the second switchable valve 54, is formed on the second face plate 16. Both the first switchable valve 51 and the second switchable valve 54 are connected to the control device 41 via the transmission device 42. In order to bring about a damping effect, both the first bypass duct 50 and the second bypass duct 53 are closed with the aid of the actuating elements 52, 55. In order to produce no damping effect, both bypass ducts 50, 53 are opened.

The method of functioning of the two embodiments and the attachment device 30 thereof corresponds to that of the first embodiment, and a detailed description is therefore not given below.

FIGS. 6 and 7 show the damping and rigidity characteristics of the damping device 10 in various switched positions of the valve 22. The profile of the dynamic rigidity and the profile of the loss angle are illustrated here.

FIG. 6 illustrates the damping and rigidity characteristics of the damping device 10 during a starting and stopping process of a motor vehicle engine 47 given an amplitude of ±4 mm and a duct diameter of 1.5 mm. This duct diameter corresponds to the diameter of the damping duct 19. It is clear here that the loss angle is at its maximum at a frequency of approximately 6 Hz and drops as the frequency increases. A high degree of damping therefore occurs at large amplitudes and low frequencies. The dynamic rigidity is, in contrast to the loss angle, small at low frequencies and large amplitudes and increases as the frequency rises. This corresponds to hardening of the bearing at high frequencies.

FIG. 7 shows the damping characteristics of the damping device 10 during the driving mode at an amplitude of ±0.05 mm and with a duct diameter (damping duct 19 and bypass duct 20) of 15 mm. From this it is clear that the loss angle owing to the opened bypass duct 20 is approximately zero and the dynamic rigidity has a value of 60 N/mm. Consequently, the damping device 10 has only a very soft transmission travel in this switched state and no humming whatsoever can be perceived by the driver in the driving mode.

In the damping device 10 described above, the damping can be changed as a function of the operating state of the motor vehicle engine 47 with the aid of the switchable valve 22. During the starting and stopping process, the bypass duct 20 is closed, with the result that damping takes place. In the driving mode, the bypass duct is opened, with the result that no humming occurs. Consequently, the damping device 10 according to the invention increases the driving comfort.

List of reference numbers

| | |
|---|---|
| 10 | Damping device |
| 11 | Intermediate plate |
| 12 | First folding bellows |
| 13 | First face plate |
| 14 | First working chamber |
| 15 | Second folding bellows |
| 16 | Second face plate |
| 17 | Second working chamber |
| 18 | Damping medium |
| 19 | Damping duct |
| 20 | Bypass duct |
| 22 | Switchable valve |
| 23 | Actuating element |
| 24 | Double arrow |
| 25 | Double arrow |
| 30 | Attachment device |
| 31 | Engine-side connecting element |
| 32 | Wheel-house-side connecting element |
| 40 | Damping system |
| 41 | Control device |
| 42 | First transmission device |
| 43 | Wheel house |
| 44 | Engine bearing |
| 45 | Holder |
| 46 | Second transmission device |
| 47 | Motor vehicle engine |
| 50 | First bypass duct |
| 51 | First switchable valve |
| 52 | First actuating element |
| 53 | Second bypass duct |
| 54 | Second switchable valve |
| 55 | Second actuating element |

1-16. (canceled)

17. A damping device for a motor vehicle, comprising:
first and second chambers each filled with a damping medium and each bounded by a folding bellows and by a face plate;
an intermediate plate separating said first and second chambers from one another, said intermediate plate having a damping duct formed therein and connecting said chambers;
at least one bypass duct connecting said first and second chambers; and
a switchable valve disposed to selectively open and close said at least one bypass duct, wherein a switched state of said valve depends on an operating state of the motor vehicle.

18. The damping device according to claim 17, configured for damping starting and stopping impacts of a motor vehicle engine of the motor vehicle.

19. The damping device according to claim 17, wherein said bypass duct has a larger cross section than said damping duct.

20. The damping device according to claim 17, wherein said bypass duct is formed in the intermediate plate.

21. The damping device according to claim 17, wherein said bypass duct connects said first and second chambers to the surroundings.

22. The damping device according to claim 17, wherein the bypass duct connects said first and second chambers to one another.

23. The damping device according to claim 17, wherein said first chamber is bounded by a first said face plate and said first face plate has a first bypass duct formed therein connecting said first chamber to the surroundings, and said second chamber is bounded by a second said face plate and said second face plate has a second bypass duct formed therein connecting said second chamber to the surroundings.

24. The damping device according to claim 17, wherein said valve is an incrementally adjustable valve or an infinitely variable valve.

25. The damping device according to claim 17, wherein said valve is configured for switching by way of a vacuum or electromagnetically.

26. The damping device according to claim 17, wherein said damping medium is air.

27. The damping device according to claim 17, wherein said folding bellows are disposed coaxially with respect to said damping duct.

28. The damping device according to claim 17, wherein said first chamber is bounded by a first said face plate and a first said folding bellows and said second chamber is bounded by a second said face plate and a second said folding bellows, and where said first face plate is attached to a front side of said first folding bellows, and said second face plate is attached to a front side of said second folding bellows.

29. The damping device according to claim 17, wherein the folding bellows have a length of between 5 mm and 20 mm.

30. The damping device according to claim 29, wherein the length of said folding bellows is between 5 mm and 10 mm.

31. The damping device according to claim 17, wherein said folding bellows have an outer diameter of between 70 mm and 100 mm.

32. The damping device according to claim 17, wherein the outer diameter of said folding bellows is between 80 mm and 90 mm.

33. The damping device according to claim 17, wherein said folding bellows is formed of a thermoplastic elastomer or a thermoplast.

34. A damping system for damping starting and stopping impacts of a motor vehicle engine, comprising:
with a damping device according to claim 17; and
a control device connected to said damping device and configured for controlling said switchable valve of said damping device in dependence on an operating state of the motor vehicle engine.

35. The damping system according to claim 34, wherein said switchable valve is closed during a starting and stopping process of the motor vehicle engine and opened in a driving mode.
